(19) United States
(12) Patent Application Publication
(10) Pub. No.: US 2024/0051838 A1
(43) Pub. Date: Feb. 15, 2024

(54) METHOD FOR PRODUCING LITHIUM HYDROXIDE

(71) Applicant: IDEMITSU KOSAN CO.,LTD., Chiyoda-ku (JP)

(72) Inventors: Shota HOSHI, Sodegaura-shi (JP); Daisuke MORI, Chiba-shi (JP); Futoshi UTSUNO, Ichihara-shi (JP); Atsushi SATO, Ichihara-shi (JP); Satoshi KATSUMATA, Chiba-shi (JP)

(73) Assignee: IDEMITSU KOSAN CO.,LTD., Chiyoda-ku (JP)

(21) Appl. No.: 18/551,635

(22) PCT Filed: Mar. 25, 2022
(86) PCT No.: PCT/JP2022/014488

§ 371 Date: Sep. 21, 2023

(30) Foreign Application Priority Data
Mar. 25, 2021 (JP) 2021-052211

(51) Int. Cl. C01D 15/02; B01D 61/46; B01D 15/20; C22B 26/12; C22B 3/24; C01D 1/40; C01D 1/42; B01J 20/06

(52) U.S. Cl. CPC C01D 15/02; B01D 61/46; B01D 15/203; C22B 26/12; C22B 3/24; C01D 1/40; C01D 1/42; B01J 20/06

(57) ABSTRACT

A method of producing lithium hydroxide using a variety of aqueous solutions as a source liquid. The method includes: providing a lithium ion extraction liquid, including a first mixing of an aqueous solution containing lithium and at least one kind of an element other than lithium and a base in a reaction tank, with a pH regulated to 6 or more and 10 or less, a second mixing of the aqueous solution and the base, with a pH regulated to 12 or more, and removal of a hydroxide of the element other than lithium formed through the first and second mixing; recovering only lithium ion from the lithium ion extraction liquid to a recovery liquid with an electrochemical device including a Li-selectively permeable membrane; and performing the regulation of pH by returning the lithium ion extraction liquid after recovering lithium ion with the electrochemical device to the reaction tank.

### TECHNICAL FIELD

The present invention relates to a method of producing lithium hydroxide.

### BACKGROUND ART

With the recent rapid spread of information-related devices and communication devices, such as a personal computer, a video camera, and a mobile phone, development of batteries used as power sources for the devices has been regarded as important. While an electrolytic solution containing a combustible organic solvent has been used in the battery for the applications, a battery having a solid electrolyte layer replacing the electrolytic solution is being developed since the all-solid state battery can simplify the safety device and is excellent in production cost and productivity.

A lithium secondary battery and the like have been used as batteries for use in the applications described above, and in recent years, the use thereof for hybrid vehicles and electric vehicles, which are developed to cope with the carbon dioxide gas emission regulation, has also been studied. Accordingly, there has been an urgent need to secure the lithium source more than ever, and as a part thereof, a technique for recovering lithium by recycling lithium secondary batteries has been developed (see, for example, PTL 1).

In addition to the recycling above, from the standpoint of the more stable securement of lithium by broadening the lithium resources, a technique for recovering lithium from salt lake brine with a manganese oxide compound as an adsorbent (see, for example, NPLs 1 and 2), a technique for recovering lithium through solar evaporation of brine (see, for example, NPLs 1 and 3), and the like are described.

A sulfide solid electrolyte has been known as a solid electrolyte used in a lithium secondary battery and the like. A sulfide solid electrolyte has a high ionic conductivity, and therefore is useful for enhancing the output power of a battery. Lithium sulfide has been widely used as a raw material for producing the sulfide solid electrolyte, and there is an increasing demand of lithium hydroxide as a raw material of lithium sulfide. The known production methods of lithium hydroxide include a method of electrolyzing an aqueous solution or a suspension liquid of lithium carbonate, and producing a lithium hydroxide aqueous solution via an ion exchange membrane (see, for example, PTL 2).

### CITATION LIST

### Patent Literatures

PTL 1: JP 2019-81953 A
PTL 2: JP 2009-270188 A

### Non-Patent Literatures

NPL 1: “Heisei 20 (2008), Technical Support Project for On-site Needs, Report of Cooperative Studies on Development of Lithium Recovery System from Brine (public version)” (Japan Organization for Metals and Energy Security, Mitsubishi Corporation), March Heisei 22 (2010), pp. 31-32
NPL 2: “Journal of MMIJ”, 2019, vol. 135, No. 9
NPL 3: “Summary of Production Technologies of Lithium—Current Status and Future Trends”, Metal Resources Reports, March 29, Heisei 31 (2019), 19-03 vol. 48

### Technical Problem

The technique described in PTL 1 recovers lithium ion from a source liquid containing lithium ion by using a lithium ion conductor, and with the increase of the demand of lithium, is demanded to achieve the enhancement of the efficiency of lithium recovery more than ever.

The technique described in PTL 2 is limited to lithium carbonate in the raw material of lithium hydroxide, and there is a demand of a further improvement for producing lithium hydroxide from the other aqueous solutions and the like containing lithium as a raw material. Furthermore, the production of lithium hydroxide by the technique described in PTL 2 or the like requires a large amount of energy consumed due to the dehydration process by heat concentration or the like, and there is a demand of reduction of the energy for producing lithium at lower cost.

The recovery of lithium, using a wide variety of aqueous solutions containing lithium, such as brine and geothermal water, as a source liquid, from the source liquid is described in NPLs 1 to 3. However, in the technique using an adsorbent described in NPL 1, impurities are removed by adding a base after adsorbing lithium to the adsorbent, resulting in a problem of impurities derived from the base remaining, and the recovery of lithium from an aqueous solution having low pH as the source liquid results in a problem that manganese oxide used as the adsorbent is eluted and thus cannot be used. In the technique using an adsorbent described in NPL 2, manganese oxide used as the adsorbent releases hydrogen ion in adsorbing lithium, resulting in a problem that the pH is decreased to impair the adsorption of lithium.

The solar evaporation described in NPLs 1 and 3 cannot be considered as efficient since the evaporation requires a long time.

The present invention has been made under the circumstances described above, and an object thereof is to provide a method of producing lithium hydroxide having high purity with high efficiency from a wide variety of aqueous solutions containing lithium as a source liquid.

### Solution to Problem

As a result of the earnest investigations made by the present inventors for solving the problems, it has been found that the problems can be solved by the invention show below.

1. A method of producing lithium hydroxide, including:
providing a lithium ion extraction liquid, including first mixing of mixing an aqueous solution containing lithium and at least one kind of an element other than lithium, and a base, in a reaction tank, with a pH regulated to 6 or more and 10 or less, second mixing of mixing the aqueous solution and the base, with a pH regulated to 12 or more, and removal of a hydroxide of the element other than lithium formed through the first mixing and the second mixing;
recovering only lithium ion from the lithium ion extraction liquid to a recovery liquid, with an electrochemical device including a Li-selectively permeable membrane; and
performing the regulation of pH by returning the lithium ion extraction liquid after recovering lithium ion with the electrochemical device, to the reaction tank.

2. The method of producing lithium hydroxide according to the item 1, wherein the providing the lithium ion extraction liquid further includes concentrating lithium ion.

3. The method of producing lithium hydroxide according to the item 2, wherein the concentrating lithium ion includes adsorbing lithium ion with an adsorbent.

4. The method of producing lithium hydroxide according to the item 3, wherein a gas generated from the electrochemical device is used for desorption of lithium ion adsorbed to the adsorbent.

5. The method of producing lithium hydroxide according to the item 4, wherein the gas is chlorine.

6. The method of producing lithium hydroxide according to any one of the items 1 to 5, wherein the method further includes isolating lithium hydroxide from the recovery liquid.

7. The method of producing lithium hydroxide according to the item 6, wherein the isolation includes crystallization.

8. The method of producing lithium hydroxide according to any one of the items 1 to 7, wherein the at least one kind of an element other than lithium is at least one kind of an element selected from calcium, magnesium, strontium, manganese, iron, zinc, and lead.

9. The method of producing lithium hydroxide according to any one of the items 1 to 8, wherein the base is at least one kind selected from an alkali metal hydroxide and an alkaline earth metal hydroxide.

10. The method of producing lithium hydroxide according to any one of the items 1 to 9, wherein the Li-selectively permeable membrane contains an oxide or an oxynitride containing lithium.

11. The method of producing lithium hydroxide according to any one of the items 3 to 10, wherein the adsorbent is at least one kind selected from a titanium oxide-based adsorbent, a manganese oxide-based adsorbent, and an antimony oxide-based adsorbent.

### Advantageous Effects of Invention

The present invention can provide a method of producing lithium hydroxide having high purity with high efficiency from a wide variety of aqueous solutions containing lithium as a source liquid.

### BRIEF DESCRIPTION OF DRAWING

FIG. 1 is a flow diagram showing one embodiment of an apparatus of producing lithium hydroxide capable of performing the method of producing lithium hydroxide according to the present embodiment.

FIG. 2 is a flow diagram showing one embodiment of an apparatus of producing lithium hydroxide capable of performing the method of producing lithium hydroxide according to the present embodiment.

FIG. 3 is a flow diagram showing the recovery device of lithium ion used in Example 2.

FIG. 4 is a graph showing the temporal change of the electric current flowing between the anode and the cathode in recovering lithium ion in Example 2.

FIG. 5 is a graph showing the temporal change of the recovery amount of lithium ion in Example 2.

### DESCRIPTION OF EMBODIMENTS

The method of producing lithium hydroxide according to one embodiment of the present invention (which may be hereinafter referred to as a “present embodiment”) will be described below. The method of producing lithium hydroxide according to one embodiment of the present invention is just one embodiment of the method of producing lithium hydroxide of the present invention, and the present invention is not limited to the method of producing lithium hydroxide according to one embodiment of the present invention. In the description herein, lithium means both lithium and lithium ion, and should be appropriately interpreted unless technical contradiction occurs.

### [Method of Producing Lithium Hydroxide]

The method of producing lithium hydroxide of the present embodiment includes: providing a lithium ion extraction liquid, including first mixing of mixing an aqueous solution containing lithium and at least one kind of an element other than lithium, and a base, in a reaction tank, with a pH regulated to 6 or more and 10 or less, second mixing of mixing the aqueous solution and the base, with a pH regulated to 12 or more, and removal of a hydroxide of the element other than lithium formed through the first mixing and the second mixing; recovering only lithium ion from the lithium ion extraction liquid to a recovery liquid, with an electrochemical device including a Li-selectively permeable membrane; and performing the regulation of pH by returning the lithium ion extraction liquid after recovering lithium ion with the electrochemical device, to the reaction tank.

In the production method of the present embodiment, before selectively recovering lithium ion, an aqueous solution containing lithium and at least one kind of an element other than lithium (which may be hereinafter referred simply to as a “source liquid”) and a base are reacted by mixing to form the element other than lithium contained in the source liquid into a hydroxide, and thereby the element can be easily removed, so as to enable the enhancement of the content of lithium ion to be recovered contained in the lithium ion extraction liquid (which may be hereinafter referred simply to as an “extraction liquid”). The enhancement of the content of lithium ion in the lithium ion extraction liquid facilitates the selective recovery of lithium ion, and thereby lithium hydroxide having high purity with less impurities can be easily obtained.

The electrochemical device including a Li-selectively permeable membrane can selectively recover lithium ion with no particular limitation in an aqueous solution containing lithium ion without the need for selecting the source liquid. Accordingly, the combination thereof with the removal of the element other than lithium in the form of a hydroxide described above enables the easier production of lithium hydroxide having high purity from a wider variety of source liquids.

The production method of the present embodiment includes performing the aforementioned regulation of pH, i.e., the regulation of pH in the reaction of the aqueous solution containing lithium and at least one kind of an element other than lithium (source liquid) and the base, by using the lithium ion extraction liquid after recovering lithium ion with the electrochemical device, specifically by returning the liquid to the reaction tank.

While lithium ion is recovered from the lithium ion extraction liquid with the electrochemical device, the entire amount thereof is not recovered, but a part thereof remains, and the extraction liquid after recovering lithium ion shows high pH (alkalinity). In the case where a hydroxide of the element other than lithium contained in the source liquid is formed through the reaction of the source liquid and the base, the hydroxide can be easily removed by performing the mixing while regulating pH, and thereby lithium hydroxide can be efficiently produced. Consequently, the returning the extraction liquid after recovering lithium ion to the reaction tank for regulating pH in the reaction by mixing the source liquid and the base enables the regulation of pH without the use of an additional chemical, and thereby the amount of the chemicals used and the waste amount thereof can be reduced. Furthermore, lithium hydroxide can be efficiently produced since the hydroxide can be easily removed, and lithium ion remaining in the extraction liquid can be recovered.

In the production method of the present embodiment, according to the manner described above, an aqueous solution that contains lithium ion can be used as the source liquid with no particular limitation without the need for selecting the kind thereof, and lithium hydroxide having high purity can be efficiently produced by efficiently recovering lithium ion from the source liquid.

### (Mixing)

In the production method of the present embodiment, an aqueous solution containing lithium and at least one kind of an element other than lithium, and a base are reacted by mixing in a reaction tank while regulating pH, and thereby a hydroxide of the element other than lithium is formed. The “mixing while regulating pH” is performed by first mixing with a pH regulated to 6 or more and 10 or less, and second mixing with a pH regulated to 12 or more. According to the procedure, at least a part of the element other than lithium can be removed, and thereby a lithium ion extraction liquid containing lithium ion with less impurities can be obtained.

The aqueous solution containing lithium and at least one kind of an element other than lithium (source liquid) is used as a raw material of lithium hydroxide obtained by the production method of the present embodiment. Examples of the aqueous solution containing lithium and at least one kind of an element other than lithium (source liquid) include a lithium-containing treated water extracted from treated members of lithium secondary batteries.

The lithium-containing treated water is not particularly limited, as far as being extracted from the treated members, and examples thereof include a lithium-containing treated water extracted from treated members of lithium secondary batteries containing a sulfide solid electrolyte, i.e., a lithium-containing treated water containing a sulfide solid electrolyte.

Examples of the aqueous solution containing lithium and at least one kind of an element other than lithium (source liquid) also include seawater, salt lake brine, mining wastewater, and geothermal water. In the production method of the present embodiment, these aqueous solutions can be used alone or as a combination of multiple kinds thereof.

Examples of the “element other than lithium” contained in the aqueous solution containing lithium and at least one kind of an element other than lithium (source liquid) include elements contained in the lithium-containing treated water, seawater, salt lake brine, mining wastewater, geothermal water, and the like described above.

Typical examples thereof include a Group 2 element (alkaline earth metal), such as calcium, magnesium, and strontium; a transition metal of 4th to 5th Period of Groups 4 to 12; such as manganese, iron and zinc and a Group 14 element, such as lead. The source liquid may contain the element alone or as a combination of multiple kinds thereof. The source liquid may possibly contain a Group 1 element (alkali metal), such as sodium and potassium, a Group 13 element, such as boron, and a halogen element, such as chlorine, as the element other than lithium, and these elements are not removed as a hydroxide from the source liquid, as similar to lithium.

Examples of the base to be reacted with the source liquid by mixing include an inorganic base and an organic base, and an inorganic base is preferred from the standpoint of the easiness in removing the element other than lithium as a hydroxide, and the more efficient production of lithium hydroxide having high purity.

Preferred examples of the inorganic base include a hydroxide of an alkali metal or an alkaline earth metal. More specifically, examples thereof include an alkali metal hydroxide, such as sodium hydroxide and potassium hydroxide, and an alkaline earth metal hydroxide, such as calcium hydroxide, magnesium hydroxide, and barium hydroxide, in which an alkali metal hydroxide is preferred, and sodium hydroxide is particularly preferred. Examples thereof also include a base having a hydrocarbon group (which may also be considered as a type of an organic base), such as tetramethylammonium hydroxide and tetraethylammonium hydroxide.

In the production method of the present embodiment, when the source liquid and the base are reacted by mixing, a hydroxide of the element other than lithium, specifically calcium hydroxide, magnesium hydroxide, strontium hydroxide, manganese hydroxide, iron hydroxide, zinc hydroxide, lead hydroxide, and the like can be removed.

The removal of the hydroxide is influenced by the pH of the mixture of the aqueous solution as the source liquid and the base, and as described above, the pH is regulated with the lithium ion extraction liquid after recovering lithium ion with the electrochemical device. As described above, the regulation of pH is necessarily divided into two stages, in which the pH in the first mixing is regulated to 6 or more and 10 or less, and the pH in the second mixing is regulated to 12 or more.

As for the influence of the pH on the removal of the hydroxide, the pH suitable for removing the hydroxide varies depending on the kind thereof.

For example, in the hydroxides shown above, iron hydroxide, zinc hydroxide, and lead hydroxide are readily removable with a pH of 6 or more and 10 or less, and calcium hydroxide, magnesium hydroxide, strontium hydroxide, manganese hydroxide, iron hydroxide, and zinc hydroxide are readily removable with a pH of 12 or more. Accordingly, in the element other than lithium, it is easy to remove iron, zinc, and lead when pH6 or more and 8 or less, and it is easy to remove calcium, magnesium, strontium, manganese, iron, and zinc when pH12 or more. Iron hydroxide and zinc hydroxide are readily removable in both the pH ranges, and accordingly, iron and zinc are readily removable in both the pH ranges. In the production method of the present embodiment, the pH in the first mixing is regulated to 6 or more and 10 or less, and the pH in the second mixing is regulated to 12 or more, in consideration of the influence of the pH.

The mixing of the source liquid and the base is performed necessarily by dividing into two stages with different pH of the mixture of the source liquid and the base. Specifically, it is necessarily performed through the first mixing with a pH regulated to 6 or more and 10 or less, and the second mixing with a pH regulated to 12 or more. The first mixing and the second mixing are preferably performed by allowing the second mixing to follow the first mixing. The reaction performed with multiple stages in this manner enables the removal of the elements in the form of hydroxide that are easily removable within the pH range set in each of the stages, and thereby the hydroxide can be efficiently removed.

The pH regulated in the first mixing is preferably 6.5 or more, and the upper limit thereof is preferably 7.5 or less, and particularly preferably 7. The pH of the mixture is a regulation target, and it suffices that the pH of the mixture is in a range of 0.5 of the regulation target since the actual pH of the mixture may slightly fluctuate around the regulation target. For example, a pH 7 means that the actual pH of the mixture is in a range of 6.5 or more and 7.5 or less, and the effect of the present invention, i.e., the production of lithium hydroxide having high purity is efficiently produced from the source liquid, can be achieved within the range.

The pH regulated in the second mixing is preferably 12 or more, more preferably 12.5 or more, and further preferably 13.5 or more, and the upper limit thereof is 14 or less. The pH regulated in the second mixing is preferably as high as possible, and particularly preferably regulated to 14.

The method of regulating the pH is not particularly limited, as far as using the lithium ion extraction liquid after recovering lithium ion with the electrochemical device. In the reaction of the source liquid and the base by mixing, the pH tends to decrease with the progress of the reaction since the base is consumed, and therefore, the pH may be regulated by continuously or intermittently supplying the lithium ion extraction liquid after recovering lithium ion with the electrochemical device.

In the removal of the hydroxide, the hydroxide of the element other than lithium is not dissolved in the mixture of the source liquid and the base but exists as a solid matter, and therefore the hydroxide can be removed by isolating the solid matter.

The isolation of the hydroxide of the element other than lithium can be performed, for example, by a convenient procedure, such as various filtration methods, such as suction filtration, and decantation. The isolation may also be performed by a combination of filtration and decantation.

### (Concentrating Lithium Ion)

In the production method of the present embodiment, the providing the lithium ion extraction liquid preferably includes concentrating lithium ion. Lithium hydroxide having higher purity can be efficiently produced by concentrating lithium ion. In the case where a precipitate other than lithium is formed by concentrating, the impurities may be removed as a pretreatment.

The concentrating lithium ion may be performed by such methods as evaporating water, removing water with a reverse osmosis membrane, adsorbing lithium ion with an adsorbent, or the like, and is preferably performed by adsorbing lithium ion with an adsorbent. By selectively adsorbing lithium ion with an adsorbent, and then desorbing lithium ion adsorbed on the adsorbent, lithium ion can be more easily concentrated, and lithium hydroxide having higher purity can be efficiently produced.

The adsorption and desorption of lithium ion with an adsorbent can be performed specifically in such a manner that lithium ion contained in the extraction liquid is selectively adsorbed on an adsorbent by bringing the lithium ion extraction liquid into contact with the adsorbent. Subsequently, lithium ion adsorbed on the adsorbent is desorbed with an acid or the like, resulting in the lithium ion extraction liquid in which the content of the element other than lithium is reduced, and lithium ion is concentrated.

Preferred examples of the adsorbent include various adsorbents, for example, a titanium oxide-based adsorbent, such as lithium titanate, a manganese oxide-based adsorbent, such as lithium manganate, an antimony oxide-based adsorbent, such as lithium antimonate, and an aluminum oxide-based adsorbent, such as aqueous aluminum oxide (Al₂O₃·xH₂O, x>0) and an activated carbon-aqueous aluminum oxide composite, and an ion exchange resin, and these materials may be used alone or as a combination thereof.

A manganese oxide-based adsorbent is preferred since lithium ion is more efficiently adsorbed thereby. The ion exchange resin is preferably a cation exchange resin, such as a weakly acidic cation exchange resin and a strongly acidic cation exchange resin, and more preferably a strongly acidic cation exchange resin having a sulfonic acid group as an exchange group.

Examples of the acid used for desorbing lithium ion from the adsorbent include an inorganic acid, such as hydrochloric acid and nitric acid.

The acid used for desorbing is preferably a gas generated from the electrochemical device described later, and more preferably chlorine. For example, in the case where the generated gas is chlorine, hydrogen chloride formed through reaction of generated chlorine with hydrogen is dissolved in water to form hydrochloric acid, which can be used as the inorganic acid for desorbing. According to the procedure, there is no necessity to supply a fresh inorganic acid, such as hydrochloric acid, and thereby the amount of the chemicals used and the waste amount thereof can be reduced, enabling the production of lithium hydroxide more efficiently.

### (Recovering Lithium Ion)

The production method of the present embodiment includes recovering only lithium ion from the lithium ion extraction liquid to a recovery liquid, with an electrochemical device including a Li-selectively permeable membrane.

The “recovering only lithium ion to a recovery liquid” means that the ion recovered does substantially not contain an ion other than lithium ion, and the content of the ion is 10% by mass or less at most, preferably 5% by mass or less, more preferably 3% by mass or less, further preferably 1% by mass or less, and particularly preferably 0.5% by mass or less.

The recovery liquid used in the present embodiment is not particularly limited, as far as being capable of dissolving lithium ion, and may be appropriately selected depending on the form of lithium finally obtained. Preferred example of the recovery liquid include pure water, such as distilled water and ion exchanged water.

In the production method of the present embodiment, the recovery liquid is supplied as water, such as ion exchanged water, to which lithium ion is allowed to migrate from the lithium ion extraction liquid obtained through the reaction by mixing the source liquid and the base and the removal of the hydroxide, with the electrochemical device including a Li-selectively permeable membrane, so as to recover lithium ion to form a recovery liquid containing lithium ion (which may be hereinafter referred simply to as a “lithium ion-containing recovery liquid”). Subsequently, lithium hydroxide is formed from the lithium ion-containing recovery liquid through a treatment, such as crystallization, and thus the recovery liquid that contains substantially no lithium ion is formed. The recovery liquid that contains substantially no lithium ion is obtained by recovering lithium ion by crystallization from lithium ion-containing recovery liquid obtained by recovering lithium ion from the lithium ion extraction liquid, and thus can be said as a recovery liquid contains substantially no lithium ion.

The lithium ion extraction liquid contains, in addition to lithium ion, the “element other than lithium” contained in the source liquid that is not removed through the reaction in the first mixing, the second mixing, and the like, and an anion, such as chloride ion. Only lithium ion is recovered to the recovery liquid with the electrochemical device, and simultaneously with the recovery, chlorine and the like contained in the extraction liquid are by-produced in the form of gas. In addition to chlorine, oxygen, hydrogen, and the like are also by-produced in the form of gas. In the gas generated from the electrochemical device, chlorine is preferred. Chlorine by-produced in the form of gas forms hydrochloric acid through reaction with hydrogen as described above, which can be used as the acid for desorbing from the adsorbent.

The lithium ion extraction liquid after recovering lithium ion from the lithium ion extraction liquid through the recovery of lithium ion contains the “element other than lithium” contained in the source liquid that is not removed through the reaction in the first mixing, the second mixing, and the like, and becomes a liquid having a high pH around pH 12 to 14. The lithium ion extraction liquid after recovering lithium ion is used for regulating the pH in the reaction by mixing the source liquid and the base as described above.

### (Electrochemical Device Including Li-Selectively Permeable Membrane)

In the production method of the present embodiment, an electrochemical device including a Li-selectively permeable membrane is used in recovering lithium ion from the lithium ion extraction liquid to the recovery liquid.

The Li-selectively permeable membrane is a membrane having a function of allowing lithium ion in the lithium ion extraction liquid to migrate to the recovery liquid, and is generally disposed to partition the extraction liquid and the recovery liquid from each other.

The Li-selectively permeable membrane is preferably constituted by a Li-selectively permeable membrane body constituted by a lithium super ionic conductor (ionic conductor) having a particularly high ionic conductivity, and a Li adsorbing layer formed as a thin layer on the extraction liquid side thereof.

The use of the lithium super ionic conductor as the Li-selectively permeable membrane body can enhance the ionic current of lithium ion flowing between the electrodes, resulting in the enhancement of the recovery efficiency of lithium. Lithium ion contained in an aqueous solution exists as hydrated lithium ion having water molecules coordinated therearound. Therefore, for further enhancing the ionic current, it is advantageous to achieve such a situation that water molecules can be easily removed at the surface of the Li-selectively permeable membrane (i.e., the interface between the Li-selectively permeable membrane and the extraction liquid).

Therefore, it is preferred that the Li adsorbing layer adsorbing lithium ion (except for the hydrate) in the lithium ion extraction liquid is formed on the surface of the Li-selectively permeable membrane. In other words, the Li-selectively permeable membrane is preferably subjected to a surface Li adsorbing treatment. Preferred examples of the Li adsorbing layer include a layer formed by modifying the surface of the material constituting the Li-selectively permeable membrane as described later.

Preferred examples of the material constituting the Li-selectively permeable membrane body include the oxides, oxynitrides, and the like containing lithium shown below. Accordingly, the Li-selectively permeable membrane preferably contains the oxides, oxynitrides, and the like containing lithium shown below.

Examples of the oxides containing lithium include lithium lanthanum titanate (Liₓ,La_{y})TiO_{z} (wherein x=3a-2b, y=⅔-a, z=3-b, 0<a≤⅙, 0≤b≤0.06, x>0) (which may be hereinafter referred to as “LLTO”), lithium lanthanum zirconate Li₇La₃Zr₂O₁₂ (which may be hereinafter referred to as “LLZO”), lithium lanthanum niobate Li₅La₃Nb₂O₁₂, and lithium lanthanum tantalate Li₅La₃Ta₂O₁₂, and LLTO used may be specifically Li_{0.29}La_{0.57}TiO₃ (a≈0.1, b≈0).

These materials each may be obtained, for example, in the form of a sintered article formed by sintering particles constituted by the material mixed with a sintering aid and the like, at a high temperature (1,000° C. or more). In this case, the surface of the Li-selectively permeable membrane can also be constituted as a porous material including fine particle constituted by LLTO bound (sintered) to each other, and thereby the effective area of the surface of the Li-selectively permeable membrane body can be increased. This is the same as not only in LLTO but also in the other oxides containing lithium, and in the oxynitride described later.

Examples of the lithium super ionic conductor that can be used as the material constituting the Li-selectively permeable membrane body include, as oxides containing Li, in addition to LLTO, LLZO, and the like described above, Li_{1+x+y}Alₓ(Ti,Ge)₂₋ₓSi_{y}P_{3-y}O₁₂ (wherein 0≤x≤0.6, 0≤y≤0.6) (Li₂O—Al₂O₃—SiO₂—P₂O₅—TiO₂—GeO₂-based material, which may be hereinafter referred to as “LASiPTiGeO”), which is a Li-substituted NASICON (Na super ionic conductor) crystal.

Preferred examples of the oxynitride containing lithium include lithium oxynitride phosphate (Li₃PON, which may be hereinafter referred to as “LiPON”), a nitride of LLTO (LLTON), a nitride of LLZO (LLZON), and a nitride of LASiPTiGeO (LASiPTiGeON).

The lithium super ionic conductor, such as the oxides, oxynitrides, and the like described above, contains lithium as one of the constitutional elements thereof, and exhibits ionic conductivity through the migration of lithium ion outside the crystal among the lithium sites in the crystal. Lithium ion can flow in the Li-selectively permeable membrane body, but sodium ion cannot flow in the Li-selectively permeable membrane. At this time, what exhibits conductivity is lithium ion (Li⁺), and hydrate ion of lithium existing in the extraction liquid along with lithium ion cannot enter the Li sites and thus does not exhibit conductivity. This mechanism is the same as in the Li-selectively permeable membrane described in WO 2015/020121 A.

In this case, in the case where only lithium ion is particularly adsorbed in a larger amount on the surface of the Li-selectively permeable membrane body with the Li adsorbing layer, water molecules of the hydrated lithium ion are excluded in adsorption, but only lithium ion is adsorbed, and thereby the conductive efficiency of lithium ion from the extraction liquid side (one of the principal surfaces) to the recovery liquid side (the other of the principal surfaces) of the Li-selectively permeable membrane body (i.e., the ionic current flowing in the Li-selectively permeable membrane body) can be enhanced.

The Li-selectively permeable membrane preferably has an anode and a cathode bonded thereto, and it is preferred that an anode is bonded to the extraction liquid side (one of the principal surfaces) of the Li-selectively permeable membrane, and a cathode is bonded to the recovery liquid side (the other of the principal surfaces) thereof. According to the configuration, one of the principal surfaces on the extraction liquid side and the other of the principal surfaces on the recovery liquid side of the Li-selectively permeable membrane are retained to a constant positive potential and a constant negative potential, respectively.

The materials used as the anode and the cathode may be appropriately a metal material that does not cause electrochemical reaction in the extraction liquid and the recovery liquid. Examples of the metal material include stainless steel, Ti, and a Ti—Ir alloy.

The aforementioned materials used as the Li-selectively permeable membrane are in a solid state, but have been known to exhibit conductivity through the flow of lithium ion in the crystal in the mode similar to free electron. Therefore, in the case where the anode is brought to a positive potential, and the cathode is brought to a negative potential, the lithium ion (positive ion) in the extraction liquid on the anode side that reaches the cathode side of the Li-selectively permeable membrane flows by ionic conductivity from the anode side (extraction liquid side) toward the cathode side (recovery liquid side) of the Li-selectively permeable membrane. The lithium ion reaching the cathode side of the Li-selectively permeable membrane is recovered to the recovery liquid. According to the mechanism, after elapsing the prescribed period of time, the lithium ion concentration in the extraction liquid is decreased, whereas the lithium ion concentration in the recovery liquid is increased.

The Li adsorbing layer may be formed as a thin layer on the surface of the Li-selectively permeable membrane body by performing a chemical treatment to the Li-selectively permeable membrane body. Specifically, the layer may be formed by subjecting one of the principal surfaces of the Li-selectively permeable membrane body (such as LLTO) to an acid treatment, for example, exposure of the surface to hydrochloric acid or nitric acid for 5 days). It is expected that the treatment forms a material layer having a composition close to H_{0.29}La_{0.57}TiO₃ (HLTO) obtained by substituting lithium, which is particularly oxidizable among the constitutional elements in the Li-selectively permeable membrane body (such as LLTO), by hydrogen in the acid. In this case, the formation of the thin layer (HLTO) on the surface can be evidenced by the existence of the peaks that are different from the Li-selectively permeable membrane body (such as LLTO) in the X-ray diffractometry in WO 2017/131051 A.

The H site in HLTO is originally a site having lithium existing therein, and therefore H is substitutable particularly by lithium ion, but is hardly substitutable by other ions (such as sodium ion). Therefore, HLTO functions as the Li adsorbing layer. HLTO is formed only on the outermost surface of the Li-selectively permeable membrane body since it is formed through reaction with an acid.

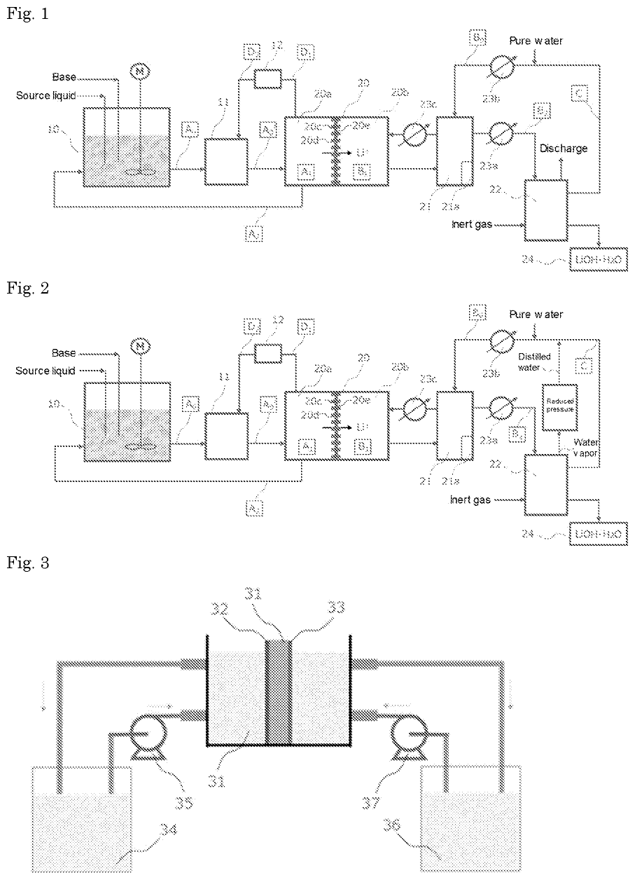

The electrochemical device including the Li-selectively permeable membrane used in the production method of the present embodiment is not particularly limited in configuration, as far as including the Li-selectively permeable membrane. FIGS. 1 and 2 show preferred embodiments of the electrochemical device used in the production method of the present embodiment. The electrochemical device used in the production method of the present embodiment preferably has the configuration shown in FIG. 1 or 2 from the standpoint of the enhancement of the production efficiency of lithium hydroxide.

The electrochemical device including the Li-selectively permeable membrane preferably includes a Li ion recovery tank 20 including at least a Li-selectively permeable membrane 20c, and a recovery liquid reservoir 21, in which the Li ion recovery tank 20 includes an extraction liquid tank 20a storing the lithium ion extraction liquid and a recovery liquid tank 20b storing the recovery liquid, and is partitioned by the Li-selectively permeable membrane 20c.

The recovery liquid reservoir 21 is used for receiving pure water freshly supplied and the recovery liquid, such as a filtrate C discharged from a crystallization device 22, and also facilitates various operation modes, for example, a batch operation in which the recovery liquid is circulated between the recovery liquid tank 20b and the recovery liquid reservoir 21 until the concentration of lithium ion in the recovery liquid recovered from the extraction liquid in the Li ion recovery tank 20 is increased to a certain concentration, circulation of the recovery liquid in the start-up of the apparatus, heating performed depending on necessity, and temporary retention of the recovery liquid.

From the standpoint of the achievement of the various operation modes, the recovery liquid reservoir 21 may have a two-tank configuration in which one tank is used as a tank for circulating the recovery liquid to the recovery liquid reservoir, and the other tank is used as a tank for receiving a fresh recovery liquid.

The recovery liquid reservoir 21 preferably has a temperature regulation unit 21a controlling the temperature of the recovery liquid. The temperature regulation unit 21a provided can control the temperature in the Li ion recovery tank 20 depending on necessity to facilitate the recovery of lithium ion, and can also achieve an operation in which the lithium ion-containing recovery liquid recovering lithium ion from the extraction liquid is heated depending on necessity in producing lithium hydroxide therefrom.

In the Li ion recovery tank 20, lithium ion extraction liquid A₂ after recovering lithium ion is used for regulating the pH in the reaction of the source liquid and the base by mixing, and therefore a discharge port is provided in the extraction liquid tank 20a of the Li ion recovery tank 20. The lithium ion extraction liquid A₂ discharged from the discharge port of the extraction liquid tank 20a is returned to the reaction tank 10.

In the case where an adsorption and desorption device 11 is used, chlorine generated in recovering lithium ion from the lithium ion extraction liquid is preferably used for desorption of lithium ion adsorbed to the adsorbent, and therefore a discharge port for chlorine is provided in the extraction liquid tank 20a of the Li ion recovery tank 20.

While not shown in the figures, for achieving various operation modes, for example, an extraction liquid reservoir storing the extraction liquid, and a pump for delivering the extraction liquid to the extraction liquid tank 20a in the Li ion recovery tank 20 may be provided.

### (Conditions in Recovering)

In recovering only lithium ion from the lithium ion extraction liquid to the recovery liquid, the recovery liquid is preferably heated. The heating accelerates the recovery of lithium ion, and thereby lithium hydroxide can be more efficiently produced.

The regulated temperature of the recovery liquid is preferably 50° C. or more, more preferably 60° C. or more, further preferably 70° C. or more, and still further preferably 80° C. or more, and the upper limit thereof is preferably 100° C. or less, more preferably 95° C. or less, and further preferably 90° C. or less. The regulated temperature of the recovery liquid herein means the set value of the temperature in regulating, and the actual temperature of the recovery liquid or the like may fluctuate around the set value. Therefore, a range of less than ±2.0° C. is included in the actual temperature of the recovery liquid. This is the same as in the temperature of the extraction liquid described later.

The temperature regulated to the aforementioned value accelerates the recovery of lithium ion, and also increases the solubility of lithium ion due to the temperature rise of the recovery liquid, by which lithium ion is suppled from the extraction liquid in an amount corresponding to the increase thereof, and thus a larger amount of lithium ion can be recovered. Furthermore, in the case where lithium ion is recovered from the extraction liquid, and lithium hydroxide is isolated from the lithium ion-containing recovery liquid, preferably produced by crystallization, the heated recovery liquid can be crystallized to produce lithium hydroxide while suppressing the energy consumption.

In the present embodiment, the pH of the extraction liquid may be regulated. By the regulation of the pH, lithium ion can be recovered more efficiently. In this case, the pH is preferably regulated to a range of 12 or more and 14 or less. The range of pH of 12 or more and 14 or less is a regulation target, and the range of pH of 12 or more and 14 or less in the present embodiment means that as for the pH of the extraction liquid, the pH of 12 includes a value of 11.5 or more and less than 12.5, and the pH of 14 includes a value of 13.5 or more and less than 14.5, and substantially means a range of 11.5 or more and less than 14.5.

In the case where the pH of the extraction liquid is regulated in the present embodiment, the method therefor is not particularly limited, and may be performed, for example, by adding an alkaline aqueous solution to the extraction liquid. The regulation of the pH of the extraction liquid may be performed in recovering lithium ion to the recovery liquid. Specifically, lithium ion may be recovered to the recovery liquid while regulating the pH of the extraction liquid, or the pH may be regulated in advance before recovering lithium ion to the recovery liquid.

Preferred examples of the alkali component of the alkaline aqueous solution used for regulating the pH of the extraction liquid include the bases exemplified as the usable materials in the reaction with the source liquid. Among them, sodium hydroxide is more preferred from the standpoint that the pH of the lithium ion extraction liquid can be rapidly regulated.

The temperature of the extraction liquid may be regulated as similar to the recovery liquid, and specifically may be heated. The procedure can facilitate the regulation of the temperature of the recovery liquid, enabling the recovery of lithium ion with high efficiency. In the case where the temperature of the extraction liquid is regulated, the regulated temperature thereof may be within the regulation range of the temperature of the recovery liquid described above.

### (Isolating Lithium Hydroxide)

In the method of producing lithium hydroxide of the present embodiment, the method of producing lithium hydroxide from the recovery liquid preferably includes isolating lithium hydroxide from the recovery liquid. Specifically, in the production method of the present embodiment, after recovering only lithium ion to the recovery liquid, lithium hydroxide is isolated from the recovery liquid containing lithium ion (lithium ion-containing recovery liquid) obtained by recovering lithium ion from the extraction liquid. According to the procedure, lithium hydroxide can be obtained without necessity of a dehydration process, such as heating and concentrating, and therefore the energy consumed in the dehydration process and the like can be reduced to provide a lithium source more efficiently.

The method of isolating is not particularly limited, as far as lithium hydroxide can be obtained from the lithium ion-containing recovery liquid, and preferred examples thereof include methods by crystallization, such as cooling crystallization and evaporation crystallization.

### (Cooling Crystallization)

In the cooling crystallization, lithium ion can be recovered more efficiently by heating the recovery liquid before the crystallization, thereby increasing the lithium ion content in the recovery liquid, and increasing the temperature difference. The specific method of the cooling crystallization is not particularly limited, as far as performing in accordance with the ordinary method of cooling crystallization, and for example, is preferably performed by blowing an inert gas to the lithium ion-containing recovery liquid while retaining a positive pressure. The inert gas blown therein can suppress the formation of lithium carbonate (which may be hereinafter referred simply to as “carbonation”), and can accelerate the formation of lithium hydroxide through the cooling crystallization, enabling the more efficient production of lithium hydroxide.

In the case where the recovery liquid is heated before the crystallization, the heating temperature is preferably 50° C. or more, and more preferably 60° C. or more, and the upper limit thereof is preferably 80° C. or less. In the case where the heating temperature is in the range, the cooling crystallization can be performed more efficiently.

The positive pressure is not particularly limited, may be approximately 0.1 to 30 kPa in terms of gauge pressure, and is preferably 0.5 to 10 kPa from the standpoint of the more efficient cooling crystallization.

The inert gas used may be nitrogen gas, argon gas, or the like. For performing the cooling crystallization under a positive pressure, the supply and discharge of the inert gas may be regulated to form the positive pressure. From the standpoint of the suppression of the carbonation, a gas containing oxygen may be used in the case where the concentration of carbon monoxide, carbon dioxide, and hydrogen carbide is 10 ppm or less. For providing lithium hydroxide having higher purity, the concentration thereof is preferably 1 ppm or less, and more preferably 0.1 ppm or less.

The cooling crystallization is preferably performed while regulating to 40° C. or less from the standpoint of the more efficient cooling crystallization. From the same standpoint, the temperature of the crystallization is preferably 35° C. or less, more preferably 30° C. or less, and further preferably 25° C. or less. The lower limit thereof is not particularly limited, may exceeds 0° C., and is preferably 3° C. or more.

In the case where the cooling crystallization is used as the crystallization, the production method of the present embodiment may include cooling the lithium ion-containing recovery liquid depending on necessity. The cooling included can positively regulate the temperature of the lithium ion-containing recovery liquid to the preferred temperature described above, and thereby the cooling crystallization can be more efficiently performed. Accordingly, it is preferred that the lithium ion-containing recovery liquid is cooled, and then the crystallization is performed, from the standpoint of the more efficient crystallization.

The method of cooling the lithium ion-containing recovery liquid may be any of an air cooling method and a water cooling method, and a cooling device may be used depending on the method used.

### (Evaporation Crystallization)

In the evaporation crystallization, the energy required for evaporation can be suppressed since the recovery liquid is heated before the crystallization. The specific method of the evaporation crystallization is not particularly limited, as far as performing in accordance with the ordinary method of evaporation crystallization, and for example, is preferably performed by regulating the temperature to 80° C. or more and 100° C. or less. The regulated temperature is more preferably 85° C. or more, and further preferably 90° C. or more, from the standpoint of the more efficient evaporation crystallization.

The evaporation crystallization is preferably performed under a reduced pressure atmosphere from the standpoint of the more efficient evaporation crystallization. By reducing the pressure, water vapor generated in the system can be discharged, and can be recovered by adding to the filtrate or the recovery liquid.

In the case where the pressure is reduced, the pressure thereof is not particularly limited, may be generally approximately 0.05 to 10 kPa as vacuum pressure, and is preferably 0.1 to 5 kPa, and more preferably 0.2 to 1 kPa, from the standpoint of the more efficient evaporation crystallization.

The evaporation crystallization may be performed while supplying an inert gas, and the inert gas used in this case may be nitrogen gas, argon gas, or the like. From the standpoint of the suppression of the carbonation, a gas containing oxygen may be used in the case where the concentration of carbon monoxide, carbon dioxide, and hydrogen carbide is 10 ppm or less. For providing lithium hydroxide having higher purity, the concentration thereof is preferably 1 ppm or less, and more preferably 0.1 ppm or less.

In the case where the crystallization described above is performed in the production method of the present embodiment, the filtrate formed in the crystallization may be added to the recovery liquid for replenishing the water of the recovery liquid since lithium ion is recovered from the recovery liquid in the form of anhydrous lithium hydroxide or lithium hydroxide hydrate. The reuse of the filtrate added to the recovery liquid can reduce the use amount of fresh pure water supplied as the recovery liquid, and thereby lithium hydroxide can be produced more efficiently. The recovery liquid, to which the filtrate is to be added, is the recovery liquid used for allowing lithium ion to migrate from the extraction liquid, and is not the lithium ion-containing recovery liquid.

The present embodiment may include a heat exchanger enabling the use of the exhaust heat in the cooling crystallization and the surplus heat occurring in the evaporation crystallization, for heating the recovery liquid. According to the configuration, the thermal efficiency can be further enhanced.

In the case where the evaporation crystallization is used, pure water formed by the evaporation crystallization can be easily reused by adding to the filtrate or the recovery liquid, and thereby the use amount of fresh pure water can be reduced. Furthermore, as compared to the case where fresh pure water is supplied, there may be a case where the filtrate having a temperature higher than the fresh pure water can be reused, and therefore lithium hydroxide can be produced more efficiently from the standpoint of the heat energy.

A filtrate is formed also in the colling crystallization. The filtrate is obtained through crystallization of lithium hydroxide from the lithium ion-containing recovery liquid, and therefore can be considered as a recovery liquid that contains substantially no lithium ion, from which lithium ion has been removed, but lithium ion contained in the recovery liquid may be contained therein in some cases. Accordingly, the filtrate cannot be considered as pure water in this case, but can be reused by adding to the recovery liquid, and thereby the use amount of fresh pure water can be reduced, enabling the more efficient production of lithium hydroxide. As described above, the filtrate formed through crystallization can be reused by adding to the recovery liquid, in both the cases using the cooling crystallization and the evaporation crystallization employed as the crystallization.

In the case where the filtrate is added to the recovery liquid, the filtrate may be heated depending on necessity. In the case where the filtrate is heated and added to the recovery liquid in the production method of the present embodiment, the temperature of the recovery liquid can be increased to accelerate the migration of lithium ion from the extraction liquid to the recovery liquid, facilitating the recovery of lithium ion to the recovery liquid, and thereby lithium hydroxide can be produced more efficiently. In the case where the filtrate is heated, the filtrate may be heated to allow the recovery liquid to have a desired temperature. The filtrate may be heated by using a heat source capable of being used for heating the recovery liquid, such as the exhaust heat in the cooling crystallization and the surplus heat occurring in the evaporation crystallization.

In the case where the filtrate is added to the recovery liquid, lithium ion may be contained in the filtrate in some cases as described above, but impurities other than lithium ion have been removed with the selectively permeable membrane, and therefore the filtrate can be reused without removal of impurities separately performed.

In the case where lithium hydroxide is obtained from the recovery liquid, lithium hydroxide obtained through crystallization is generally monohydrate (LiOH·H₂O). In the production method of the present embodiment, the resulting lithium hydroxide obtained by isolating lithium hydroxide from the filtrate through solid-liquid isolation or the like may be directly used in some applications, and may also be used after dehydration.

In the case where monohydrate of lithium hydroxide is dehydrated, for example, the dehydration may be performed through a drying process generally employed, such as heating and reduction of pressure.

### (Apparatus of Producing Lithium Hydroxide)

FIGS. 1 and 2 each are a flow diagram showing one typical embodiment of an apparatus of producing lithium hydroxide capable of performing the method of producing lithium hydroxide of the present embodiment. Both the diagrams assume the case where crystallization is employed in isolating lithium hydroxide from the recovery liquid, in which FIG. 1 shows the case using cooling crystallization, and FIG. 2 shows the case using evaporation crystallization.

The apparatus of producing lithium hydroxide shown in FIG. 1 includes a reaction tank 10 reacting the source liquid and the base by mixing, a Li ion recovery tank 20 recovering lithium ion, and a crystallization device 22 as an isolating device isolating lithium hydroxide from the recovery liquid (i.e., a lithium ion-containing recovery liquid B₂) after recovering lithium ion in the Li ion recovery tank 20, and depending on necessity, may also include an adsorption and desorption device 11 including an adsorbent, a hydrochloric acid preparation tank 12 preparing hydrochloric acid to be supplied to the adsorption and desorption device 11, a recovery liquid reservoir 21 storing the recovery liquid, heat exchangers 23a, 23b, and 23c, and a drying device 24.

As described above, the Li ion recovery tank 20 includes an extraction liquid tank 20a storing the extraction liquid A₁, a recovery liquid tank 20b storing the recovery liquid B, and a Li-selectively permeable membrane 20c, and the extraction liquid tank 20a and the recovery liquid tank 20b are partitioned from each other by the Li-selectively permeable membrane 20c. The Li-selectively permeable membrane 20c has a first electrode 20d (anode) on one of the principal surfaces (the extraction liquid A₁ side) and a second electrode 20e (cathode) on the other of the principal surfaces (the recovery liquid B side), and the recovery liquid reservoir 21 has a temperature regulation unit 21a capable of regulating the temperature of the recovery liquid. A piping for returning the lithium ion extraction liquid A₂ after recovering lithium ion from the extraction liquid tank 20a to the reaction tank 10 is provided.

The apparatus of producing lithium hydroxide shown in FIG. 2 includes, as similar to the production apparatus shown in FIG. 1, a reaction tank 10, an adsorption and desorption device 11, a hydrochloric acid preparation tank 12, a Li ion recovery tank 20, a recovery liquid reservoir 21 storing the recovery liquid, a crystallization device 22, heat exchangers 23a, 23b, and 23c, and a drying device 24. The Li ion recovery tank 20 includes an extraction liquid tank 20a, a recovery liquid tank 20b, and a Li-selectively permeable membrane 20c, and the Li-selectively permeable membrane 20c has a first electrode 20d (anode) on one of the principal surfaces (the extraction liquid A₁ side) and a second electrode 20e (cathode) on the other of the principal surfaces (the recovery liquid B side).

The production apparatus shown in FIG. 2 uses evaporation crystallization in the crystallization device 22, and thus is different from the production apparatus shown in FIG. 1 in the point that a recovery line allowing distilled water obtained by reducing the pressure of water vapor generated from the crystallization device 22 to be a recovery liquid. In the Li ion recovery tanks 20 shown in FIGS. 1 and 2, oxygen and hydrogen are formed in the extraction liquid tank 20a and the recovery liquid tank 20b, respectively, through electrolysis of water, and therefore piping capable of discharging and recovering them is preferably provided.

The reaction tank 10 is a tank for mixing the source liquid and the base, and preferably includes an agitator for accelerating the reaction of the source liquid and the base. The removal of the hydroxide formed through the reaction may be performed by various filtration methods, such as suction filtration, and decantation as described above, and for example, a filtering device or a tank for decantation may be provided between the reaction tank 10 and the adsorption and desorption device 11. The reaction tank 10 may also have a discharge port for discharging the hydroxide formed through the reaction.

In FIGS. 1 and 2, the lithium ion extraction liquid A₀ obtained by reacting the source liquid and the base by mixing in the reaction tank 10 and then removing the hydroxide is supplied to the adsorption and desorption device 11, in which lithium ion contained in the extraction liquid A₀ is adsorbed, and the extraction liquid A₀′ after desorbing lithium ion adsorbed to the adsorbent is suppled to the extraction liquid tank 20a of the Li ion recovery tank 20. In the case where the adsorption and desorption device 11 is not provided, the lithium ion extraction liquid A₀ discharged from the reaction tank 10 is directly supplied to the extraction liquid tank 20a.

The reaction by mixing the source liquid and the base in the reaction tank 10 is performed while regulating pH. The pH is regulated with the lithium ion extraction liquid A₂ after recovering lithium ion with the electrochemical device including at least the Li ion recovery tank 20 preferably having the Li-selectively permeable membrane 20c, and the recovery liquid reservoir 21, as described above. Therefore, a piping for delivering the extraction liquid A₂ from the electrochemical device, more specifically from the extraction liquid tank 20a, to the reaction tank 10 is provided.

For delivering the extraction liquid A₂, a pump may be provided, and a reservoir for temporarily storing the extraction liquid A₂ may be provided.

In the case where the adsorption and desorption device 11 is used, chlorine generated in recovering lithium ion from the lithium ion extraction liquid is preferably used for desorption of lithium ion adsorbed to the adsorbent, as described above.

In recovering lithium ion from the lithium ion extraction liquid in the Li ion recovery tank 20, chlorine contained in the extraction liquid is generated as a by-product. Chlorine D₁ generated may be formed into hydrochloric acid D₂ in the hydrochloric acid preparation tank 12, and may be used as an inorganic acid for desorbing lithium ion adsorbed to the adsorbent from the adsorbent in the adsorption and desorption device 11. A reservoir for temporarily storing hydrochloric acid prepared in the hydrochloric acid preparation tank 12 may also be provided.

In the Li ion recovery tank 20, lithium ion contained in the extraction liquid A₁ is allowed to migrate from the extraction liquid A₁ to the recovery liquid B₁ with the Li-selectively permeable membrane 20c, and recovered to the recovery liquid B₁, and the recovery liquid B₁ is supplied as the lithium ion-containing recovery liquid B₂ to the crystallization device 22 via the recovery liquid reservoir 21.

The production apparatuses shown in FIGS. 1 and 2 each include the heat exchanger 23a for heating the lithium ion-containing recovery liquid B₂ to the prescribed temperature. The heat exchanger 23a used may be a shell tube type heat exchanger using a medium as shown in FIG. 1, and may also be a jacket type heat exchanger using electricity, a heat medium, or the like, a heater type heat exchanger, of the like. The heat source thereof may be the exhaust heat in the cooling crystallization, the surplus heat occurring in the evaporation crystallization, and the like. This is the same as in the heat exchangers 23b and 23c described later.

In the production apparatus shown in FIG. 1, lithium hydroxide crystallized in the crystallization device 22 and the filtrate formed in crystallization are isolated through solid-liquid isolation or the like, and lithium hydroxide is further dried with the drying device 24 and withdrawn in the form of lithium hydroxide monohydrate (LiOH·H₂O) as a product. The filtrate C is heated with the heat exchanger 23b along with pure water that is freshly supplied depending on necessity, and then supplied to the recovery liquid tank 20b of the Li ion recovery tank 20 in the form of the recovery liquid B₀ containing substantially no lithium ion via the recovery liquid reservoir 21, after heating with the heat exchanger 23c depending on necessity. The fact that the recovery liquid B₀ contains substantially no lithium ion means that water, such as pure water, becomes the recovery liquid B₀ in the case where the filtrate C is not contained therein, and thus contains substantially no lithium ion, and in the case where the filtrate C is contained, means that there is a possibility that lithium ion is contained in the filtrate C, but the content of lithium ion thereof is smaller than the recovery liquids B₁ and B₂ since the filtrate is obtained by removing lithium ion through crystallization of lithium hydroxide from the recovery liquid B₁ stored in the recovery liquid tank 20b and the lithium ion-containing recovery liquid B₂ supplied to the crystallization device 12.

In the production apparatus shown in FIG. 2 employing evaporation crystallization, water vapor is discharged by reducing pressure or the like from the crystallization device 22 and cooled to form distilled water, which is recovered as the filtrate C, and as similar to the production apparatus shown in FIG. 1, crystallized lithium hydroxide and a filtrate in the form of liquid are formed, and the filtrate in the form of liquid is also recovered as the filtrate C.

The Li ion recovery tank 20 may have a configuration in which one tank is partitioned with the Li-selectively permeable membrane 20c to provide the extraction liquid tank 20a and the recovery liquid tank 20b separated from each other, or may have a configuration in which two tanks, i.e., the extraction liquid tank 20a and the recovery liquid tank 20b, are connected via the Li-selectively permeable membrane 20c.

In the production apparatus in FIG. 1, the temperature regulation is performed for the temperature of the recovery liquid in the recovery liquid tank 20b. For regulating the temperature of the recovery liquid B₁ in the recovery liquid tank 20b, at least one of the heat exchangers 23b and 23c may be used before supplying the recovery liquid B₀ to the recovery liquid tank 20b, or the temperature regulation unit 21a provided in the recovery liquid reservoir 21 may also be used. For example, in the case where the production apparatus does not have the temperature regulation unit 21a, the temperature of the recovery liquid B₀ at the outlet port of at least one of the heat exchangers 23b and 23c is heated to a temperature slightly higher than the prescribed temperature, and thereby the temperature of the recovery liquid in the recovery liquid tank 20b may be regulated to the prescribed temperature. In the case where the temperature regulation unit 21a is provided and used, the temperature of the recovery liquid B₀ at the outlet port of the heat exchanger 23b may not be heated to the prescribed temperature. A temperature regulation unit corresponding to the temperature regulation unit 21a in the recovery liquid reservoir 21 may be provided in the recovery liquid tank 20b.

From the standpoint of the regulation of the recovery liquid to have the prescribed temperature more securely and stably, it is preferred to provide the temperature regulation unit 21a in addition to the heat exchanger 23b as shown in FIG. 1.

It is advantageous to provide the heat exchanger 23c for regulating the temperature of the recovery liquid in the recovery liquid tank 20b to the prescribed temperature in the case where a batch operation is performed in addition to the heating the recovery liquid B₀, for example, the recovery liquid is circulated between the recovery liquid tank 20b and the recovery liquid reservoir 21 until the concentration of lithium ion contained in the recovery liquid B₁ is increased to a certain concentration.

The temperature of the extraction liquid may also be regulated as described above, and a heating unit (not shown in the figures) therefor may also be provided. In this case, as similar to the recovery liquid, an extraction liquid reservoir and a heat exchanger may be provided, and the extraction liquid may be heated with the heat exchanger while circulating between the extraction liquid tank 20a and the reservoir. The extraction liquid may be heated by a heat exchanger provided in the extraction liquid reservoir, and a heat exchanger may be provided in the extraction liquid tank 20a.

The production apparatus preferably includes the recovery liquid reservoir 21.

The recovery liquid reservoir 21 provided facilitates a batch operation in which the recovery liquid is circulated between the recovery liquid tank 20b and the recovery liquid reservoir 21 until the concentration of lithium ion contained in the recovery liquid B₁ is increased to a certain concentration, and enables various operation modes, for example, circulation and heating of the recovery liquid in the start-up of the production apparatus, and temporary retention of the filtrate in supplying the filtrate as the recovery liquid to the recovery liquid tank. Furthermore, the combination thereof with the heat exchanger 23c and the temperature regulation unit 21a facilitates the heating of the recovery liquid in the batch operation and the circulation in the start-up of the production apparatus described above, and thereby the recovery liquid can be regulated to have the prescribed temperature more securely and stably.

The temperature regulation unit 21a is not particularly limited, as far as being a unit capable of regulating the temperature of the recovery liquid, and for example, may be a heat exchanger or in the form of an air conditioning device heating the entire recovery liquid reservoir 21. In the case where a heat exchanger is used, the type thereof is not particularly limited and may be selected depending on the use mode, and as similar to the heat exchangers 22a to 22c, for example, a shell tube type heat exchanger using a medium, a jacket type heat exchanger using electricity, a heat medium, or the like, and a heater type heat exchanger may be used. In heating, the heat source thereof may be the exhaust heat in the cooling crystallization, the surplus heat occurring in the evaporation crystallization, and the like.

In the case where crystallization is used for isolating lithium hydroxide from the lithium ion-containing recovery liquid B₂, the crystallization device 22 is preferably used. The crystallization device 22 is a device provided for crystallizing lithium hydroxide from the recovery liquid containing lithium ion obtained by recovering lithium ion in the Li ion recovery tank 20 (lithium ion-containing recovery liquid). For example, in the case of a batch operation in which the recovery liquid is circulated between the recovery liquid tank 20b and the recovery liquid reservoir 21 until the concentration of lithium ion contained in the recovery liquid B₁ is increased to a certain concentration, the crystallization may be performed in such a manner that after increasing to the certain concentration, a part or the whole of the recovery liquid B₁ is withdrawn as the lithium ion-containing recovery liquid B₂ and delivered to the crystallization device 22.

The crystallization device 22 may use cooling crystallization, evaporation crystallization, or the like as crystallization as described above, and therefore a device suitable for the mode of crystallization may be used, and a commercially available crystallization device may also be used.

The crystallization device 22 may have a device for isolating crystallized lithium hydroxide and the filtrate, such as a solid-liquid isolating device, depending on necessity.

In the case where cooling crystallization is used as crystallization, as in the production apparatus shown in FIG. 1, a supplying line of an inert gas for supplying and discharging an inert gas for retaining the positive pressure, and a pressure regulating valve and a discharge line for discharging corresponding to the pressure in the crystallization device 22 may also be provided.

In the case where evaporation crystallization is used as crystallization, as in the production apparatus shown in FIG. 2 using evaporation crystallization, a pressure reducing device for discharging the filtrate formed in the device as water vapor may be provided, and a cooling device for cooling the filtrate discharged as water vapor to form a filtrate in the form of liquid, i.e., distilled water, may also be provided.

The drying device 24 is a device for drying lithium hydroxide containing water that has not been isolated after the isolation of the crystallized lithium hydroxide and the filtrate in the crystallization device 22, so as to form lithium hydroxide monohydrate (LiOH·H₂O) or anhydrous lithium hydroxide.

The dryer used in the drying device 24 may be appropriately selected depending on the desired extent, scale, and the like of drying, and examples thereof used include a heating device, such as a hot plate, a horizontal dryer or a horizontal vibration flow dryer having a heating unit and a delivering mechanism, a Henschel mixer capable of drying by heating to approximately 50 to 140° C. and agitating generally under a reduced pressure atmosphere of approximately 1 to 80 kPa, and a device commercially available as an FM mixer.

(Method of producing Lithium Sulfide)

Lithium hydroxide produced by the method of producing lithium hydroxide of the present embodiment can be used as a raw material of lithium sulfide. Therefore, the method of producing lithium hydroxide of the present embodiment can be applied to a method of producing lithium sulfide. Specifically, the production method of the present embodiment can be applied to a method of producing lithium sulfide, including producing lithium hydroxide by the method of producing lithium hydroxide of the present embodiment, and supplying hydrogen sulfide to the resulting lithium hydroxide.

In supplying hydrogen sulfide to lithium hydroxide, for example, lithium hydroxide and hydrogen sulfide gas are placed in a reaction vessel, and reacted under agitation, so as to provide lithium sulfide. In this case, lithium hydroxide may be a hydrate or an anhydrate, and in consideration of the efficiency, it is preferred that the hydrate is directly reacted with hydrogen sulfide.

The reaction temperature of lithium hydroxide and hydrogen sulfide may be generally 120° C. or more and 300° C. or less, preferably 140° C. or more and 230° C. or less, more preferably 150° C. or more and 220° C. or less, and further preferably 160° C. or more and 210° C. or less. In the case where the reaction temperature is in the range, the reaction is accelerated to enable to provide lithium sulfide having high purity with a reduced amount of lithium hydroxide remaining.

The reaction time is preferably 1 hour or more and 60 hours or less, preferably 2 hours or more and 30 hours or less, and preferably 6 hours or more and 20 hours or less. In the description herein, the reaction time means a period of time of reacting by bringing hydrogen sulfide into contact with lithium hydroxide, and more specifically, a period of time from the start of supply of hydrogen sulfide to the termination of supply thereof.

Lithium sulfide can also be produced by supplying hydrogen sulfide to the recovery liquid in the method of producing lithium hydroxide of the present embodiment described above.

The method of supplying hydrogen sulfide is not particularly limited, and in the case where hydrogen sulfide is supplied to the recovery liquid, hydrogen sulfide gas may be supplied by blowing into the recovery liquid. While lithium sulfide and water are formed through the reaction of lithium hydroxide and hydrogen sulfide, water produced is appropriately removed, and after substantially removing water finally, the blowing hydrogen sulfide is terminated to provide lithium sulfide.

In the case where hydrogen sulfide is supplied to the recovery liquid, the reaction may be performed in such a manner that hydrogen sulfide gas is supplied to the crystallization device of the apparatus of producing lithium hydroxide, i.e., hydrogen sulfide gas is blown into the lithium ion-containing recovery liquid, or may be performed in such a manner that the lithium ion-containing recovery liquid is supplied to a separate vessel, and hydrogen sulfide gas is blown to the vessel by any method of a closed system (batch method) and a flow system.

Lithium sulfide obtained in this manner may be purified depending on necessity. The purification method is not particularly limited, and an ordinary method may be used.

### EXAMPLES

The present invention will be described specifically with reference to examples below, but the present invention is not limited to the examples.

### (Measurement of Contents of Elements)

1 mL of a specimen was collected to a fluorine resin container, and then diluted with approximately 10 mL of ultrapure water, to which 5 mL of nitric acid was added for dissolving, and then heated on a hot plate at 120° C. for 10 minutes. After cooling to room temperature, the specimen was appropriately diluted depending on the concentrations of the elements contained therein, and measured for the contents of the elements contained in the specimen, for example, the lithium ion extraction liquid, by the calibration curve method or the standard addition method with an ICP emission spectrophotometer (“5100 ICP-OES” (model number), available from Agilent Technologies, Inc.).

### Preparation Example (Preparation of Source Liquid)

3 L of geothermal water around the Salton Sea was agitated and allowed to stand for one week, and then the supernatant was collected and designated as a source liquid (see Table 1).

### Example 1 (Preparation of Lithium Ion Extraction Liquid)

9 mL of the source liquid (pH 2) was collected, and reacted with 1 ml of a 1 M sodium hydroxide aqueous solution by mixing through agitation, so as to perform the first mixing (pH 7). After agitation, solid-liquid isolation was performed through suction filtration with a hydrophilic membrane filter (formed of PTFE, pore diameter: 0.45 μm). 1 mL of the filtrate was collected in a fluorene resin container, and diluted with approximately 10 mL of ultrapure water, to which 5 mL of nitric acid was added for dissolving, and then heated on a hot plate at 120° C. for 10 minutes. After cooling to room temperature, the specimen was appropriately diluted depending on the concentrations of the elements contained therein, and measured for the contents of the elements by the standard addition method with an ICP emission spectrophotometer. The results are shown in Table 1.

Subsequently, 2 g of sodium hydroxide (granular) was added to 10 mL of the filtrate (pH 7) and reacted by mixing through agitation, so as to perform the second mixing (pH 14). After agitation, solid-liquid isolation was performed through suction filtration with a hydrophilic membrane filter (formed of PTFE, pore diameter: 0.45 μm), so as to provide lithium ion extraction liquid. 1 mL of the extraction liquid was collected in a fluorene resin container, and measured for the contents of the elements by the standard addition method with an ICP emission spectrophotometer in the same manner as above. The results are shown in Table 1.

TABLE 1

| | Source liquid | After first mixing | After second mixing |
|---|---|---|---|
| | mg/L | mg/L | mg/L |
| Li | 310 | 280 | 270 |
| K | 19000 | 16000 | 22000 |
| Na | 45000 | 43000 | 110000 |
| B | 570 | 530 | 450 |
| Ca | 73000 | 67000 | <10 |
| Mg | 60 | 50 | <10 |
| Sr | 730 | 630 | 60 |
| Mn | 1900 | 1800 | <10 |
| Fe | 2100 | 100 | <10 |
| Pb | 120 | <10 | <10 |
| Zn | 690 | 90 | 80 |

It was confirmed from the above results that iron, lead and zinc were removed in the form of hydroxides by the first mixing (pH 7), and calcium, iron, magnesium, manganese, strontium, and zinc were removed in the form of hydroxides by the second mixing (pH 14).

### (Recovery Device of Lithium Ion)

A recovery device shown in FIG. 3 was used as the recovery device of lithium ion used in recovering lithium ion in Example 2.

The recovery device of lithium ion shown in FIG. 3 includes a Li isolation membrane cell 30 including a Li isolation membrane 31 held with an anode 32 and a cathode 33, a fed liquid tank 34, a fed liquid circulation pump 35, a recovery liquid tank 36, and a recovery liquid circulation pump 37.

The Li isolation membrane cell 30 has a structure including a Li isolation membrane laminate having a Li isolation film (material: LLTO) 31 held with collectors (material: carbon) inserted therein, held with an anode 32 (material: platinum) and a cathode 33 (material: platinum). Electric power can be supplied to the anode 32 and the cathode 33 from a constant voltage device, and the Li ion is recovered from the source liquid in the anode chamber to the recovery liquid in the cathode chamber with the electric power supplied.

The fed liquid as a target of recovery of lithium ion is supplied to the fed liquid tank 34, and can be circulated between the anode chamber of the Li isolation membrane cell 30 and the fed liquid tank 34 with the fed liquid circulation pump 35. The recovery liquid, to which lithium ion is recovered from the fed liquid, is supplied to the recovery liquid tank 36, and can be circulated between the cathode chamber of the Li isolation membrane cell 30 and the recovery liquid tank 36 with the recovery liquid circulation pump 37.

### Example 2 (Recovery Test of Lithium Ion)

Recovery of lithium ion was performed by using the lithium ion extraction liquid obtained through the second mixing in Example 1. The device shown in FIG. 3 was used as the recovery device of lithium ion.

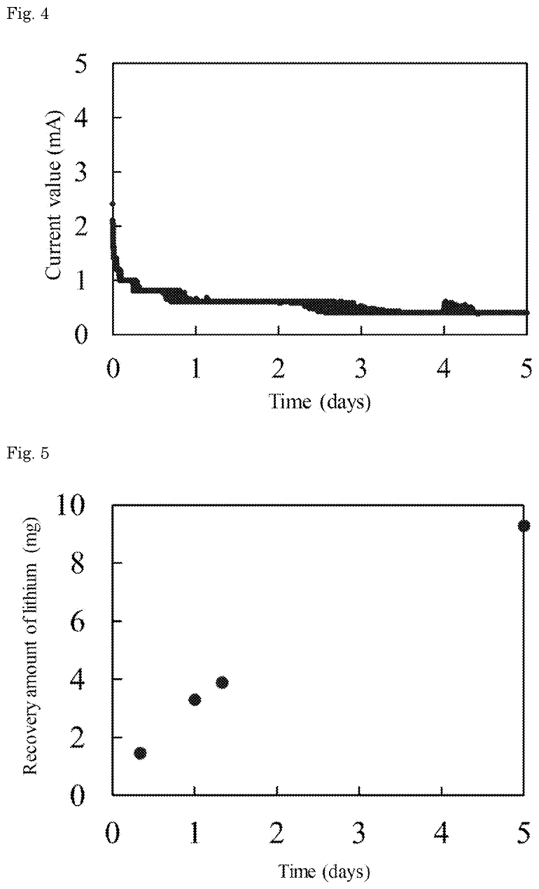

100 mL of the lithium ion extraction liquid obtained through the second mixing in Example 1 was placed in the fed liquid tank 34 as the fed liquid to the recovery device of lithium, pure water was placed as the recovery liquid in the recovery liquid tank 36, and the fed liquid and the recovery liquid were circulated with the fed liquid circulation pump 35 and the recovery liquid circulation pump 37, respectively. A voltage of 5 V was applied from a constant voltage device, at which the current value flowing between the anode and the cathode was measured for measuring the recovery amount of lithium. The maximum current value was 2.4 mA as shown in FIG. 4. The current value became substantially 0 after 120 hours of voltage application, at which the recovery rate of lithium was 30% by mass (recovery amount: 9.3 mg). The recovery rate of lithium herein means a ratio of the amount of lithium element in the recovery liquid after recovering lithium with respect to the amount of lithium element in the fed liquid before recovering lithium. The temporal change of the recovery amount of lithium is shown in FIG. 5.

It was understood therefrom that lithium ion was recovered from the lithium ion extraction liquid by using the recovery device shown in FIG. 3.

### Example 3 (Reuse of Fed Liquid after Recovering Lithium)

The fed liquid (i.e., the lithium ion extraction liquid obtained in Example 1) after recovering lithium ion has a high pH and therefore can be reused for regulating the pH of the geothermal water used as the source liquid in Example 1. 10 mL of the fed liquid after the lithium ion recovery test in Example 2 (lithium extraction liquid, pH 14) was added to 100 mL of the source liquid (geothermal water, pH 2), and reacted by mixing through agitation, so as to perform the first mixing (pH 7). After agitation, solid-liquid isolation was performed through suction filtration with a hydrophilic membrane filter (formed of PTFE, pore diameter: 0.45 μm). 1 mL of the filtrate was collected in a fluorene resin container, and measured for the contents of the elements by the standard addition method with an ICP emission spectrophotometer (“5100 ICP-OES” (model number), available from Agilent Technologies, Inc.) in the same manner as in Example 1. The results are shown in Table 2.

Subsequently, 50 mL of the fed liquid after the lithium ion recovery test in Example 2 (lithium extraction liquid, pH 14) was added to 10 mL of the filtrate (pH 7) and reacted by mixing through agitation, so as to perform the second mixing (approximately pH 14). After agitation, solid-liquid isolation was performed through suction filtration with a hydrophilic membrane filter (formed of PTFE, pore diameter: 0.45 μm), so as to provide lithium ion extraction liquid. 1 mL of the extraction liquid was collected in a fluorene resin container, and measured for the contents of the elements by the standard addition method with an ICP emission spectrophotometer (“5100 ICP-OES” (model number), available from Agilent Technologies, Inc.) in the same manner as above. The results are shown in Table 2.

It was confirmed from the results that the fed liquid after recovering lithium ion (lithium extraction liquid) could be reused for the removal of impurities of geothermal water through regulation of pH.

TABLE 2

| | Source liquid | After first mixing | After second mixing |
|---|---|---|---|
| | mg/L | mg/L | mg/L |
| Li | 310 | 260 | 200 |
| K | 19000 | 16000 | 21000 |
| Na | 45000 | 49000 | 100000 |
| B | 570 | 520 | 460 |
| Ca | 73000 | 61000 | <10 |
| Mg | 60 | 50 | <10 |
| Sr | 730 | 580 | 10 |
| Mn | 1900 | 1600 | <10 |
| Fe | 2100 | 90 | <10 |
| Pb | 120 | <10 | <10 |
| Zn | 690 | 80 | 70 |

### Example 4 (Production of Lithium Hydroxide)

100 mL of the lithium recovery liquid obtained in the lithium ion recovery test in Example 2 was concentrated and dried up by heating to 100° C. on a hot plate under a nitrogen atmosphere, so as to provide 9 mg of lithium hydroxide monohydrate (LiOH·H₂O). The measurement with an X-ray diffraction device (“D₈ DISCOVER Plus” (trade name), available from Bruker Corporation), revealed that the resulting peaks were consistent with lithium hydroxide monohydrate (ICDD Card No. 01-076-1073), from which it was confirmed that the resulting solid matter was lithium hydroxide monohydrate.

5 mg of the resulting lithium hydroxide monohydrate was weighed to a fluorine resin container, and then diluted with approximately 10 mL of ultrapure water, to which 5 mL of nitric acid was added for dissolving, and then heated on a hot plate at 120° C. for 10 minutes. After cooling to room temperature, the specimen was diluted, and measured for the content of Li by the calibration curve method with an ICP emission spectrophotometer (“5100 ICP-OES” (model number), available from Agilent Technologies, Inc.). As a result, it was confirmed that the content thereof was 16.5% by mass, which was the same as the theoretical content of lithium hydroxide monohydrate (LiOH·H₂O).

### Comparative Example 1

Lithium ion was recovered in the same manner as in Example 1 except that in Example 2, the lithium ion extraction liquid obtained through the second mixing in Example 1 was not used, but the source liquid prepared in Preparation Example was used. A voltage of 5 V was applied from a constant voltage device, at which the current value flowing between the anode and the cathode was measured for measuring the recovery amount of lithium. The maximum current value was 1.2 mA, and current value after one hour of voltage application was 0.1 mA. The current value became substantially 0 after 12 hours of voltage application.

It is considered that the maximum current value in Comparative Example 1 is small due to the effect of the ion other than lithium and the failure of the reaction of lithium ion efficiently occurring on the surface of the selectively permeable membrane since the base is not mixed through the first mixing and the second mixing.

It was confirmed from the aforementioned results that the method of producing lithium hydroxide of the present embodiment can achieve efficient recovery of lithium ion, and thereby the method can use a wide variety of aqueous solutions containing lithium as a source liquid, and can produce lithium hydroxide having high purity efficiently from the source liquid.

### REFERENCE SIGNS LIST

10: Reaction tank
11: Adsorption and desorption device
12: Hydrochloric acid preparation tank
20: Li ion recovery tank
20a: Extraction liquid tank
20b: Recovery liquid tank
20c: Li selectively permeable membrane
20d: First electrode
20e: Second electrode
21: Recovery liquid reservoir
21a: Temperature regulation unit
22: Crystallization device
23a: Heat exchanger
23b: Heat exchanger
23c: Heat exchanger
24: Drying device
30: Li isolation membrane cell
31: Li isolation membrane
32: Anode
33: Cathode
34: Fed liquid tank
35: Fed liquid circulation pump
36: Recovery liquid tank
37: Recovery liquid circulation pump
A₀: Lithium ion extraction liquid
A₀′: Lithium ion extraction liquid (after adsorption and desorption)
A₁: Lithium ion extraction liquid (in extraction liquid tank)
A₂: Lithium ion extraction liquid after recovering lithium ion
B₀: Recovery liquid
B₁: Recovery liquid (in recovery liquid tank)
B₂: Lithium ion-containing recovery liquid
C: Filtrate
D₁: Chlorine
D₂: Hydrochloric acid

1: A method of producing lithium hydroxide, comprising:
providing a lithium ion extraction liquid, including:
a first mixing of mixing an aqueous solution containing lithium and at least one element other than lithium, and a base, in a reaction tank, with a pH regulated to 6 or more and 10 or less,
a second mixing of mixing the aqueous solution and the base, with a pH regulated to 12 or more, and
removal of a hydroxide of the element other than lithium formed through the first mixing and the second mixing;
recovering only lithium ion from the lithium ion extraction liquid to a recovery liquid, with an electrochemical device including a Li-selectively permeable membrane; and
performing a regulation of pH by returning the lithium ion extraction liquid after recovering the lithium ion with the electrochemical device, to the reaction tank.

2: The method of producing lithium hydroxide according to claim 1, wherein the providing the lithium ion extraction liquid further comprises concentrating lithium ion.

3: The method of producing lithium hydroxide according to claim 2, wherein the concentrating lithium ion comprises adsorbing lithium ion with an adsorbent.

4: The method of producing lithium hydroxide according to claim 3, wherein a gas generated from the electrochemical device is used for desorption of lithium ion adsorbed to the adsorbent.

5: The method of producing lithium hydroxide according to claim 4, wherein the gas is chlorine.

6: The method of producing lithium hydroxide according claim 1, wherein the method further comprises isolating lithium hydroxide from the recovery liquid.

7: The method of producing lithium hydroxide according to claim 6, wherein the isolating comprises crystallization.

8: The method of producing lithium hydroxide according to claim 1, wherein the at least one element other than lithium is at least one element selected from the group consisting of calcium, magnesium, strontium, manganese, iron, zinc, and lead.

9: The method of producing lithium hydroxide according to claim 1, wherein the base is at least selected from the group consisting of an alkali metal hydroxide and an alkaline earth metal hydroxide.

10: The method of producing lithium hydroxide according to claim 1, wherein the Li-selectively permeable membrane contains an oxide or an oxynitride containing lithium.

11: The method of producing lithium hydroxide according to claim 3, wherein the adsorbent is at least one selected from the group consisting of a titanium oxide-based adsorbent, a manganese oxide-based adsorbent, an antimony oxide-based adsorbent, an aluminum oxide-based adsorbent and an ion exchange resin.
